(19) United States
(12) Patent Application Publication
(10) Pub. No.: US 2009/0078651 A1
(43) Pub. Date: Mar. 26, 2009

(54) Mung Water Treatment Method

(75) Inventors: David Bronson Gregory, Kawkawlin, MI (US); William Wayne Soper, Bay City, MI (US)

Correspondence Address: REISING, ETHINGTON, BARNES, KISSELLE, P.C., P O BOX 4390, TROY, MI, 48099-4390, US

(73) Assignee: ReNew Systems, Inc., Bay City, MI (US)

(21) Appl. No.: 12/020,045

(22) Filed: Jan. 25, 2008

Related U.S. Application Data
(60) Provisional application No. 60/995,336, filed on Sep. 26, 2007.

(51) Int. Cl. C02F 1/50

(52) U.S. Cl. 210/739; 210/764

(57) ABSTRACT

A water treatment method for reducing/eliminating and preventing biofilm buildup in recirculating water systems. The method includes providing both NuTower™ and a biocide in a recirculating water system.

### CROSS-REFERENCES TO RELATED APPLICATIONS

This application claims priority from Provisional Application No. 60/995,336, filed Sep. 26, 2007 and entitled “Mung Water Treatment Method”.

### STATEMENT REGARDING FEDERALLY SPONSORED RESEARCH OR DEVELOPMENT

Not Applicable

### BACKGROUND OF THE INVENTION

1. Field of the Invention

This invention relates generally to a water treatment method for reducing or eliminating, and then preventing biofilm and chemical odor-producing residue buildup in recirculating closed-loop water systems such as industrial process water or “mung” water systems and such water systems using cooling towers.

2. Description of the Related Art Including Information Disclosed Under 37 CFR 1.97 and 1.98

In nutrient starved ecosystems, bacteria have a tendency to adhere to surfaces and start the formation of biofilms. A biofilm is a community of microbes, contained within an organic polymer matrix, adhering to a surface. In natural and industrial ecosystems, especially in nutrient limited systems, biofilms will prevail and cause problems such as increased fouling of water contact surfaces, decreased heat transfer from heat exchangers, increased corrosion of metallic substrates and transfer of contamination in the food, cosmetic and biotechnology industry.

A biofilm is a collection of microcolonies, typically with water channels in between, and an assortment of cells and cell excretions such as polysaccharides, glycoproteins and proteins. Bacteria growing in biofilms are more resistant to biocides than planktonic cells and resistance increases with the age of the biofilm. Bacterial biofilms also exhibit increased physical resistance to desiccating environments, changing temperatures and light. Biofilm formation causes industrial and environmental problems and the difficulties in cleaning and disinfection of bacterial biofilms with chemicals is a major concern in many industries. There is a trend towards milder cleaning compositions but the art lacks an efficient cleaning system for surfaces covered with biofilms.

It is common for recirculating closed-loop industrial process water systems to accumulate biofilm. As it only takes a few millimeters of biofilm to start decreasing the efficiency of cooling towers often used in such systems, treatments have been developed to control biofilm buildup. Because bacteria are known to be primarily responsible for the formation of biofilms in process water systems, biocides such as chlorine are commonly introduced in an effort to prevent or eliminate biofilms. It is also often necessary to introduce other agents such as acids, caustics, and inhibitors into recirculating water systems—chemistries that cause corrosion. Consequently, it is also often necessary to introduce a corrosion inhibitor to the system. pH control agents and anti-scale agents are also often necessary additives. As a result, as many as 5-8 different chemistries may have to be maintained in recirculating water systems to effectively deal with the biofilm problem.

To provide an environmentally-friendly biodegradable biocide alternative, DOW Chemical Company developed 2.2-dibromo-3-nitrilopropionamide, which is commonly referred to as DBNPA. DBNPA is designed to biodegrade within 48 hours of being introduced into a recirculating water system and leaves no signature on the environment. DBNPA is commercially available from the DOW Chemical Company and has obtained agency approvals for use in recirculating water systems and for discharge into the environment. However, known water treatment methods using DBNPA still require the introduction of multiple chemistries to eliminate and prevent biofilm buildup in recirculating water systems.

Odor Out® is a water treatment additive that is commercially available from ReNew® Systems, Inc. and JohnsonDiversey, Inc., assignees of the present invention. Odor Out® is formulated to break down odors in sewers and drains, industrial wastes, sludges, manures, composting, etc. found in locations such as municipal plants, commercial operations, and manufacturing operations. Theoretically, Odor Out® works by breaking odor causing molecules rather than by perfuming or masking odors. For the above purposes, Odor Out® is known to be used at a dilution rate of 1 to 2 gallons per 1,000 gallons of water and is normally applied by mist or spray directly on compost, waste pits, or is added directly to sludges. Waste water treatment methods using Odor Out® have been known to include pre-testing dosages to determine optimum concentration an amount of product to be used in a given application.

Odor Out® FDA, a version of Odor Out® that includes no fragrances or dyes, was developed by ReNew® Systems, Inc. to meet FDA requirements for use as an odor-reducing water treatment additive in water systems that release water into the environment. Odor Out® FDA is now commercially available from ReNew® Systems, Inc. and JohnsonDiversey, Inc. under the trade name NuTower™. However, NuTower™ is known to cause foaming when used in high concentrations in recirculating water systems and may require the addition of a de-foaming agent

What would be desirable would be a simple, environmentally-friendly water treatment method that would eliminate and prevent biofilm buildup in recirculating water systems using a minimum number of different chemistries.

### BRIEF SUMMARY OF THE DISCLOSURE

A water treatment method is provided for reducing/eliminating and preventing biofilm buildup in recirculating water systems. According to this method one can reduce biofilm buildup in recirculating water systems by providing both NuTower™ (formerly Odor Out® FDA) and biocide in the recirculating water system.

The combination of NuTower™ and biocide as been empirically determined to act synergistically against biofilm buildup in a recirculating water system while eliminating or drastically reducing the need to maintain other chemistries in such a system. The need for a corrosion inhibitor is lowered or eliminated, the amount of acid needed to manage pH (concentrating due to water evaporation drives the solution basic) is reduced or eliminated, and the need for anti-scale agents is eliminated (except in very hard water). The combined use of NuTower™ and biocide also reduces the amount of biocide required and generally allows NuTower™ to be used in small enough concentrations to preclude foaming and to thus obviate the need for a defoaming agent.

### BRIEF DESCRIPTION OF THE DRAWINGS

These and other features and advantages will become apparent to those skilled in the art in connection with the following detailed description and drawings of one or more embodiments of the invention in which:

FIG. 1 is a flow chart showing a first method for reducing and preventing biofilm buildup in recirculating water systems according to the present invention;

FIG. 2 is a flow chart showing a second method for reducing and preventing biofilm buildup in recirculating water systems according to the present invention; and

FIG. 3 is a flow chart showing a third method for reducing and preventing biofilm buildup in recirculating water systems according to the present invention.

### DETAILED DESCRIPTION OF INVENTION EMBODIMENT(S)

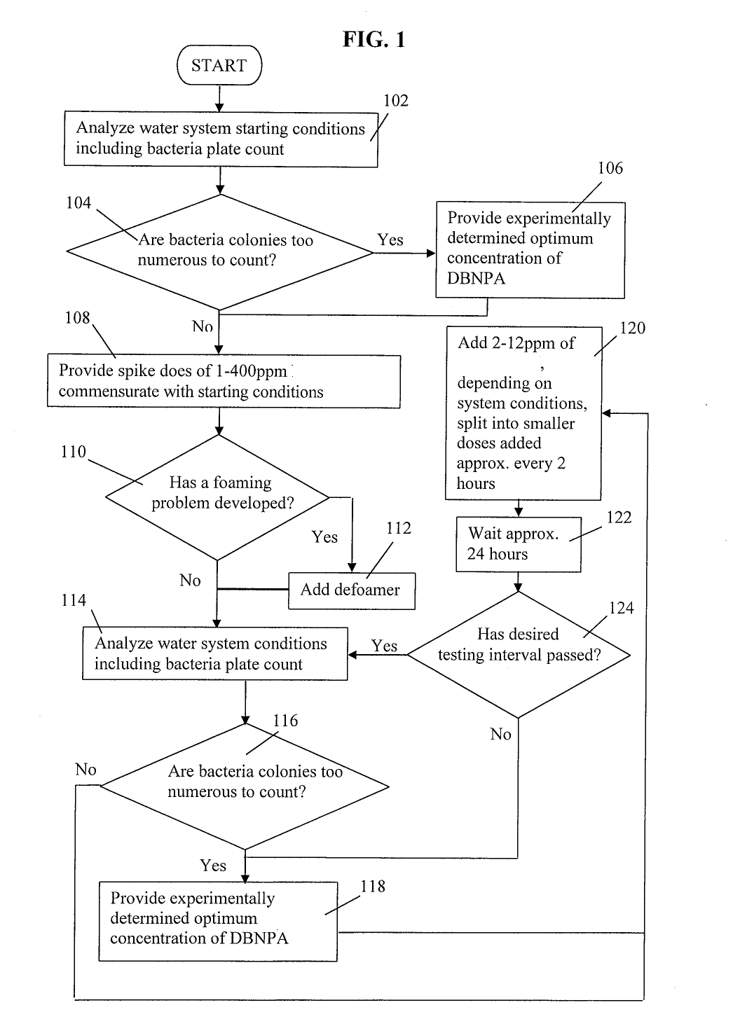

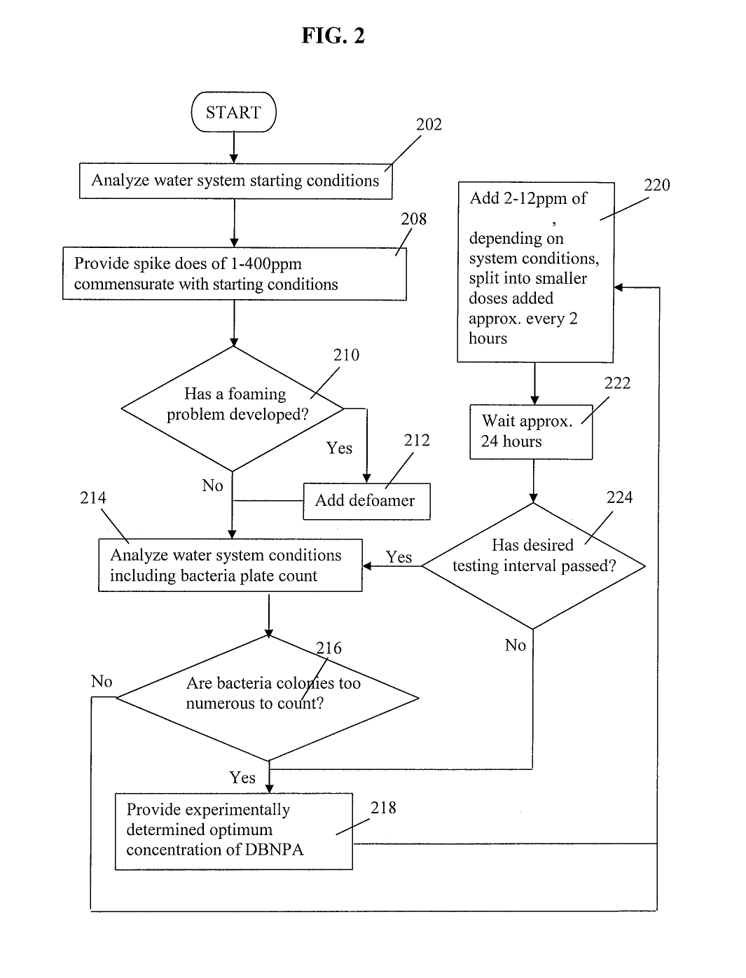

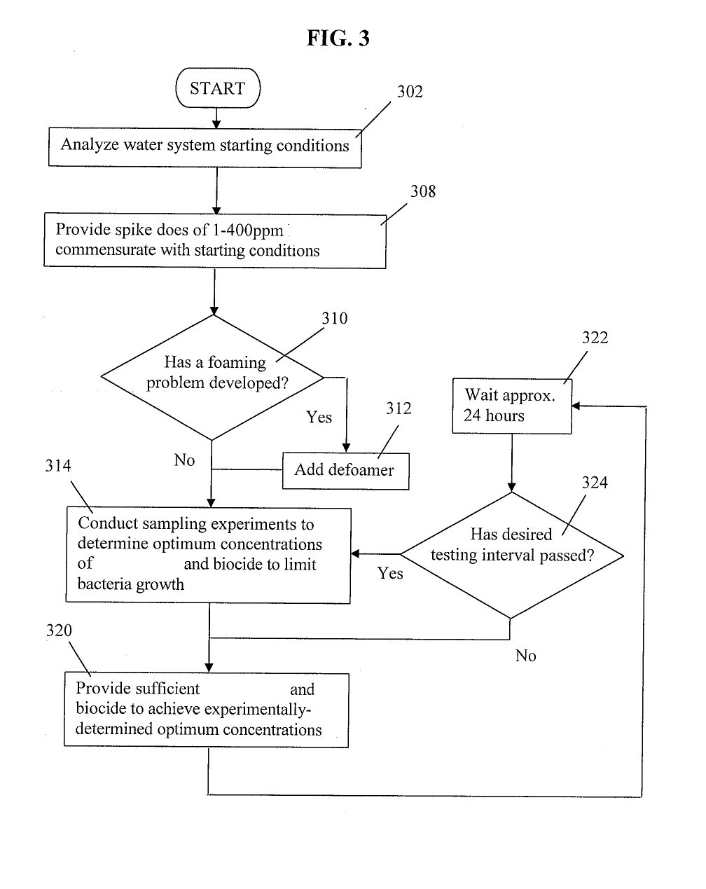

A water treatment method for reducing/eliminating and preventing biofilm and chemical odor-producing residue buildup in recirculating closed-loop water systems is generally shown at 100 in FIG. 1. A second water treatment method is shown at 200 in FIG. 2 and a third method at 300 in FIG. 3.

As shown at action steps 108 and 118 in FIG. 1, steps 208 and 218 in FIG. 2, and step 318 in FIG. 3, each method includes providing both NuTower™ (formerly Odor Out® FDA) and a kill agent or biocide in a recirculating closed-loop water system such as an industrial or “mung” water system that may include one or more cooling towers. However, before introducing NuTower™ and/or biocide into a recirculating water system, the system may first be analyzed to determine starting conditions/system loading as shown at action steps 102, 202, and 302 in FIGS. 1, 2 and 3, respectively. The dosing of NuTower™ and/or biocide may then be calculated to be commensurate with the starting conditions, i.e., worse starting conditions call for more NuTower™ and/or biocide.

As shown at action steps 108, 208, and 308 in FIGS. 1, 2, and 3, respectively, the initial introduction of NuTower™ into a system may be in the form of an initial spike dose or shock treatment of NuTower™ sufficient to provide a mass concentration of 1-400 ppm or more in the water system. The size of the spike dose may be calculated to be sufficient to provide a mass concentration toward the low end of the 1-400 ppm range, e.g., within a range of 2-12 ppm of NuTower™, depending, again, on starting conditions—a range of concentrations that has generally been found to be sufficient for most recirculating water systems. However, some systems, such as those including large amounts of fats and greases, or those having high biochemical/chemical oxygen demand (BOD-COD) loading, may benefit from a spike dose sufficient to provide a concentration of NuTower™ at the high end of the 1-400 ppm range. In one trial, a spike dose of NuTower™ was added to a system that already included a biocide, with sufficient NuTower™ being added to provide a concentration of 400 ppm NuTower™. This combination of a high dosage of NuTower™ with biocide cleaned the system entirely.

A NuTower™ concentration of more than 400 ppm has generally been found to be counterproductive. Such high concentrations of NuTower™ appear to defeat flocking action that NuTower™ is intended to provide, as evidenced by a resulting lack of precipitate. Such high NuTower™ concentrations may also reduce surface tension of the recirculating water system to an excessive degree and can break loose large biofilm buildups leading to system clogging problems. Large doses of NuTower™ can also cause foaming. When this occurs, a defoamer such as Foam Out®, also available from ReNew® Systems, Inc., may be added to the system as shown in decision steps 110, 210, and 310 and action steps 112, 212, and 312 in FIGS. 1-3.

Following the NuTower™ spike dose, a maintenance dosing of NuTower™ may be provided in the recirculating water system as shown in action steps 120, 220, and 320 in FIGS. 1-3. As shown in steps 122, 222, and 322, this may be done on a daily basis. Each day the amount of NuTower™ provided in the recirculating water system may be calculated to be sufficient to provide a mass concentration of approximately 2-12 ppm as shown in steps 120 and 220 in FIGS. 1 and 2, but a daily amount of NuTower™ sufficient to provide a concentration of 5 ppm has been found to be sufficient under most circumstances. As is also indicated in steps 120 and 220, the daily amount of NuTower™ sufficient to provide these concentrations is generally divided into smaller doses delivered to the system at a dosing frequency of one dose every 2 hours. However, the daily amount of NuTower™ may be provided at any other suitable dosing rate that may be found to be more effective under various system conditions.

The initial spike dose of NuTower™ may be, but generally is not greater than subsequent daily maintenance dosing. It depends on the starting conditions of the recirculating water system. If the recirculating water system starting conditions include biofilm, significant odor, or high septicity (low DO), then an initial spike dose of NuTower™ significantly greater than subsequent daily amount providing in maintenance doses is indicated.

As shown in action steps 114, 214, and 314 in FIGS. 1-3, the condition of a recirculating water system may be analyzed before initiating maintenance dosing and then, as shown in decision steps 124, 224, and 324, periodically analyzed thereafter at desired testing intervals. As indicated in action steps 120 and 220 in FIGS. 1 and 2, the NuTower™ maintenance dosing may be adjusted accordingly following each such analysis. The periodic analyses may be terminated once desired conditions are achieved or may be continued to insure that desired conditions are maintained.

The adjustment of NuTower™ maintenance dosing may, in each case, be commensurate with a measured degree of change in conditions as determined through periodic analysis of the system, i.e., less NuTower™ in response to improved conditions. A daily amount of NuTower™ to be introduced may be calculated based on observed and/or measured conditions and then that daily amount may be spread out over each day, e.g., one dose every two hours, with each dose equaling a percentage of the daily amount, may be introduced into the recirculating water system. This may be done by any suitable means to include the use of a programmable electronic dosing pump.

Frequent dosing insures that, at all times, there's sufficient NuTower™ present and active in the recirculating water system to handle whatever influent might enter the system at any time. The desired conditions to be achieved through periodic analysis and NuTower™ dosage adjustments may be defined by such factors as the absence of biofilm, the absence of algae, a level of suspended solids (SS) approximating 30-40 ppm, the successful enhancement of desirable biological aspects of the system such that soils and deposits are continuing to be consumed, the successful inhibition of undesirable biological aspects of the system, and nutrients present in the system at a level of less than 2 ppm ammonia and less than 2 ppm phosphorous.

As shown in action steps 118 and 218 in FIGS. 1 and 2, respectively, the biocide provided in the recirculating water system may include the active ingredient 2.2-dibromo-3-nitrilopropionamide (DBNPA). DBNPA is available from The DOW Chemical Company in a 5% solution under the trade name DOW Antimicrobial 8536 and in a 20% solution under the trade name DOW Antimicrobial 7287. The DBNPA may already be present in the system when NuTower™ is added, may be added together with NuTower™, and/or may be provided into a system as a daily maintenance additive as shown in action steps 118 and 218.

When, as shown at action step 106 in FIG. 1, DBNPA is to be added to a recirculating water system either before or at approximately the same time as an initial dose of NuTower™, the amount of DBNPA may be determined in accordance with visually and/or experimentally determined initial conditions of the system. When, as shown at action steps 118 and 218 in FIGS. 1 and 2, respectively, DBNPA is to be added to the system after the initial dose of NuTower™, then the DBNPA may be dosed into the recirculating water system at a rate corresponding to the post-shock treatment conditions obtained in a post-shock analysis of the system.

As indicated in action steps 102 and 114 in FIG. 1 and action step 214 in FIG. 2, starting condition testing and/or subsequent analyzing following shock treatment may include determining bacteria count (number of bacteria per liter) and/or plate count (number of bacteria colonies on a standard test plate) taken from a water sample drawn from the recirculating water system. Biocide dosing rate may then be determined in response to that bacteria count or plate count and in an amount sufficient to achieve a concentration of 0-0.5 ppm DBNPA in the recirculating water system commensurate with the bacteria count or plate count. In general, the need for DBNPA in a system may be indicated by a plate count greater than 100 or, alternatively, by the growth of bacteria colonies too numerous to count. As indicated in action steps 106 and 118 in FIG. 1, and in action step 218 in FIG. 2, the optimum target concentration of DBNPA may be determined by conducting sampling experiments including, e.g., observing bacteria colony growth in serial dilutions of DBNPA in water system samples.

Starting condition observations and measurements and any follow-up system analyses may include, in addition to bacteria count, sensory indications such as the presence of biofilm, algae, odor; and measurements of other indications such as septicity as determined by measuring dissolved oxygen level (DO). Other measurable indications of system conditions may include chemical oxygen demand (COD), biochemical oxygen demand (BOD), suspended solids (SS), pH, fats, oils, greases, and levels of phosphorous and ammonia. These values may be measured by any suitable means known in the art to include the measurement of BOD using a respirometer such as an Oxi-top™ device, and the measurement of dissolved oxygen level by using an electronic meter to measure the partial pressure of oxygen in the water and then converting that value to oxygen mass concentration. Alternatively, a field test kit may be used such as a drop bottle, a microburet, or a digital titrator that adds a solution of known strength to a treated sample of water. The amount of solution required to change the color of the sample reflects the mass concentration of DO in the sample. A DO of less than 1 mg/L is considered septic while a DO of 3 mg/L is considered moderate. A DO of 6 to 9 mg/L is generally considered to indicate a healthy system.

Alternatively, or in addition, and as shown at action step 314 in FIG. 3, initial starting condition observations and measurements as well as any follow-up system analysis may include conducting bacteria growth experiments (plating) with varying concentrations of biocide and NuTower™ to determine optimum respective biocide and NuTower™ concentrations for limiting bacteria growth. As shown at action step 320 in FIG. 3, sufficient NuTower™ and biocide may then be dosed into the recirculating water system to reach and maintain the respective experimentally-determined optimum biocide and NuTower™ concentrations. As shown at action step 322 and decision step 324 in FIG. 3, the bacteria growth experiments may be repeated at desired testing intervals to insure that optimum concentrations of NuTower™ and biocide are being maintained in accordance with changing system conditions.

The combined use of NuTower™ and biocide has proven to be an effective way of reducing or eliminating biofilm in a recirculating closed-loop water system, for preventing biofilm buildup in such a system, and for eliminating chemical odor-producing residue buildup. This method is entirely scalable and, in addition to industrial mung water systems with cooling towers, may be successfully implemented in other recirculating water systems such as hot tub water systems, garden ponds, fish ponds, fish tanks, and large-scale aquariums.

Fresh water is generally introduced either continuously or periodically into recirculating water systems and so-called “blowdown water” is likewise released either continuously or periodically from such systems. Although blowdown water treated with NuTower™ and biocide as described above is generally free of biofilm, algae, and other contaminants that adversely affect system performance, it's not always suitable for release into the environment. To complete the preparation of blowdown water for release into the environment Hydrozyme®, a water treatment additive commercially available from ReNew® Systems and JohnsonDiversey, may be added to such blowdown water as the blowdown water is released from the recirculating water system or may be added to waste treatment tanks, ponds, or lagoons where such blowdown water is accumulated for treatment. It has been found that the combined effect of the use of biocide and NuTower™ in a recirculating water system and the use of Hydrozyme® in blowdown water from the system, is sufficient to prepare the blowdown water for release into the environment.

On 27 Sep. 2006 an experimental was conducted to compare the effects of treating mung water with DBNPA only to the effects of treating mung water with both DBNPA and Odor-Out®. The set-up for this experiment is shown in Table 1, below:

TABLE 1
Experimental Set-up

| | | Mung | DBNPA | Odor Out |
|---|---|---|---|---|
| | | Water | 0.05% | 1% Aged |
| | | (ml) | (μl) | (ml) |
| Blank | 0a | 50 | — | — |
| Blank w/ DBNPA | 1a | 50 | 10 | — |
| Odor Out@100 ppm | 5a | 49.5 | 10 | 0.5 |
| Odor Out@400 ppm | 6a | 48 | 10 | 2 |

The experiment was set-up in 250 ml baffled shake flasks with dispo plugs. The Odor Out® solutions used in this experiment were “aged”, having been prepared on 12 Sep. 2006 in tap water. The DBNPA solution was made up just prior to making additions to the flasks and was made using distilled water.

After mung water samples and DBNPA and Odor Out® treatment additives were added, the flasks were placed in an incubation shaker set at 30 degrees C. and shaken at 100 rpm. The experiment was started at 2:30 p.m. on 27 Sep. 2006. The flasks were shaken for 2½ hours at which point the shaker was turned off and the flasks were allowed to incubate in a stationary position overnight. The next day, on 28 Sep. 2006 from 11 a.m.-2 p.m., serial dilutions were made up and most probable number plates were prepared.

The plates were incubated overnight at 30 degrees C. On 29 Sep. 2006 the plates were inspected and colonies were counted and recorded as shown in Table 2:

TABLE 2
Results of Most Probable Number Plates T = 24

| | | Straight | 10⁻¹ | 10⁻² | 10⁻³ | 10⁻⁴ | 10⁻⁵ | 10⁻⁶ | 10⁻⁷ |
|---|---|---|---|---|---|---|---|---|---|
| Blank | 0a | TNC | TNC | TNC | 58 | 7 | 0 | 1 | 1 |
| Blank | 1a | TNC | TNC | 5 | 1 | 0 | 0 | 0 | 0 |
| w/ | | | | | | | | | |
| DBNPA | | | | | | | | | |
| Odor | 5a | TNC | 60 | 10 | 2 | 0 | 0 | 0 | 1 |
| Out ® | | | | | | | | | |
| @100 | | | | | | | | | |
| ppm | | | | | | | | | |
| Odor | 6a | TNC | TNC | 315 | 36 | 5 | 1 | 0 | 0 |
| Out ® | | | | | | | | | |
| @400 | | | | | | | | | |
| ppm | | | | | | | | | |

Note:
The symbol “TNC” in Table 2, above, indicates where the colonies on the plates were too numerous to count (>300).

As shown in Table 2, moderate reductions in bacteria colony counts resulted in plates containing mung water samples treated only with DBNPA. Plates containing samples treated both with DBNPA and Odor Outs at 100 ppm had significantly lower bacteria colony counts than did plates containing untreated samples and had moderately lower counts than did the plates containing samples treated only with DBNPA. Plates containing samples treated with Odor Out® at 400 ppm yielded bacteria colony counts that were slightly higher than those of the plates containing untreated samples, moderately higher than those of the plates containing samples treated only with DBNPA, and significantly higher than all the other plates containing treated samples.

Additional data was collected from the samples as shown in Table 3, below:

TABLE 3
Measured Parameters

| | | | pH | DO | DO | COD | COD |
|---|---|---|---|---|---|---|---|
| | | pH @ 0 | @ 24 | @ 0 | @ 24 | @ 0 | @ 24 |
| Blank | 0a | 8.11 | 8.04 | 8.5 | 7.8 | 0 | 0 |
| Blank | 1a | 8.03 | 7.98 | 8.8 | 8.0 | 0 | 0 |
| w/DBNPA | | | | | | | |
| Odor Out ® | 5a | 8.11 | 8.08 | 8.6 | 7.8 | 0 | 13 |
| @100 ppm | | | | | | | |
| Odor Out ® | 6a | 8.09 | 8.10 | 8.2 | 7.7 | 44 | 77 |
| @400 ppm | | | | | | | |

As shown in Table 3, no substantial changes occurred in the pH of any of the four sample categories. DO was slightly to moderately lower after 24 hours in all four categories. The only COD detected was in the samples treated with Odor Out® at 100 ppm and 400 ppm, respectively, and likely resulted from the product itself.

The experimental data presented in tables 1-3 shows that when Odor Outs is added to mung water that has already been treated with “kill” agent, the bacteria plate count reduction is even greater than that caused by kill agent treatment—indicating that Odor Out® magnifies the effect of the “kill” agent. The exception to this result occurred in mung water samples treated with Odor Out® at 400 ppm, i.e., counts actually rose moderately.

This description, rather than describing limitations of an invention, only illustrates embodiments of the invention recited in the claims. The language of this description is therefore exclusively descriptive and is non-limiting. Obviously, it's possible to modify this invention from what the description teaches. Within the scope of the claims, one may practice the invention other than as described above.

What is claimed is:

1. A method for reducing and preventing biofilm buildup in recirculating water systems, the method including the steps of:
providing NuTower™ in a recirculating water system; and
providing biocide in the recirculating water system.

2. The method of claim 1 including the additional steps of:
determining starting conditions by analyzing the recirculating water system before the step of providing NuTower™ in the recirculating water system; then
providing a shock dose of NuTower™ in the recirculating water system commensurate with the starting conditions determined in the analyzing step.

3. The method of claim 1 including the additional steps of:
determining starting conditions by analyzing the recirculating water system before the step of providing biocide in the recirculating water system; then
providing a quantity of biocide in the recirculating water system commensurate with the starting conditions determined in the analyzing step.

4. The method of claim 2 in which the step of providing NuTower™ in a recirculating water system includes providing an initial shock dose/shock treatment of NuTower™ sufficient to provide a mass concentration of 1-400 ppm or more in the water system depending on starting conditions.

5. The method of claim 2 in which the step of providing NuTower™ in a recirculating water system includes providing sufficient NuTower™ to provide a mass concentration of 2-12 ppm of NuTower depending on starting conditions.

6. The method of claim 1 in which the step of providing NuTower™ in a recirculating water system includes the additional steps of:
observing whether foaming results from the addition of NuTower™; and
adding defoamer to the system if foaming is observed.

7. The method of claim 2 including the additional step of providing maintenance dosing of NuTower™ in the recirculating water system following the shock dose.

8. The method of claim 7 in which the step of providing NuTower™ maintenance dosing includes providing NuTower™ maintenance dosing at an approximate frequency of one dose every 2 hours.

9. The method of claim 7 in which the step of providing NuTower™ maintenance dosing includes providing NuTower™ in the recirculating water system at a rate of approximately 2-10 ppm per day.

10. The method of claim 7 in which the step of providing NuTower™ maintenance dosing includes providing NuTower™ in the recirculating water system at a rate of approximately 5 ppm per day.

11. The method of claim 7 in which the step of providing NuTower™ maintenance dosing includes providing sufficient NuTower™ in the recirculating water system to maintain a mass concentration of approximately 12 ppm.

12. The method of claim 7 in which the step of providing NuTower™ maintenance dosing includes periodically analyzing the condition of the recirculating water system and adjusting NuTower™ maintenance dosing accordingly until desired conditions are achieved.

13. The method of claim 12 in which the step of adjusting NuTower™ maintenance dosing includes adjusting NuTower™ maintenance dosing commensurate with a measured degree of change in conditions.

14. The method of claim 12 in which the step of adjusting NuTower™ maintenance dosing includes adjusting NuTower™ maintenance dosing until desired conditions have been achieved and are being sustained, the desired conditions being defined as one or more of the conditions selected from the group consisting of: absence of biofilm and algae, a SS level of 30-40 ppm, desirable biological aspects of water enhanced sufficiently to continue consuming soils and deposits, undesirable biological aspects inhibited, and nutrients at a level of less than 2 ppm ammonia and less than 2 ppm phosphorous.

15. The method of claim 1 in which a maintenance dosing of biocide is provided in the recirculating water system.

16. The method of claim 15 in which the step of providing maintenance dosing of biocide includes providing maintenance dosing of biocide an approximate frequency of one dose per day.

17. The method of claim 3 in which the step of providing biocide in the recirculating water system commensurate with starting conditions includes providing DBNPA in the recirculating water system

18. The method of claim 17 in which the step of determining starting conditions includes determining bacteria count and including the additional step of providing DBNPA in the recirculating water system in sufficient quantity to achieve a concentration in the range of 0-0.5 ppm DBNPA in the recirculating water system commensurate with the bacteria count.

19. The method of claim 1 in which the step of providing biocide includes providing sufficient biocide in the recirculating water system to achieve an experimentally determined optimum target concentration of biocide.

20. The method of claim 19 in which the optimum target concentration of biocide is determined by observing bacteria colony growth in serial dilutions of biocide in water system samples.

21. The method of claim 2 in which the step of analyzing the recirculating water system includes taking a bacteria count from a water sample drawn from the recirculating water system.

22. The method of claim 2 in which: the step of analyzing the recirculating water system includes:
conducting bacteria growth experiments with varying concentrations of biocide and NuTower™ to determine optimum respective biocide and NuTower™ concentrations for limiting bacteria growth; and
the steps of providing biocide a shock dose of NuTower™ include providing sufficient NuTower™ and biocide in the recirculating water system to reach the respective experimentally-determined optimum biocide and NuTower™ concentrations.

23. The method of claim 2 in which the step of analyzing the recirculating water system includes sensing the presence of one or more conditions selected from the group consisting of biofilm, algae, and odor.

24. The method of claim 2 in which the step of analyzing the recirculating water system includes measuring one or more conditions selected from the group consisting of bacteria count, septicity as determined by measuring dissolved oxygen level (DO), chemical oxygen demand (COD), biochemical oxygen demand (BOD), suspended solids (SS), pH, fats, oils, greases, and levels of phosphorous and ammonia.

25. The method of claim 1 in which Hydrozyme® is added to blowdown water released from the recirculating water system.
